(19) United States
(12) Patent Application Publication
(10) Pub. No.: US 2005/0205102 A1
(43) Pub. Date: Sep. 22, 2005

(54) Method of making surface modified silica gel

(75) Inventors: Zuyin Yang, Midlothian, VA (US); John B. Paine III, Midlothian, VA (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Philip Morris USA Inc.

(21) Appl. No.: 11/051,637

(22) Filed: Jan. 27, 2005

Related U.S. Application Data
(60) Provisional application No. 60/540,070, filed on Jan. 30, 2004.

(51) Int. Cl. B01D 15/08

(52) U.S. Cl. 131/207; 131/200; 131/202

(57) ABSTRACT

A method of treating silica gel to improve its characteristics as a filter material. The method comprises the steps of preparing surface modified silica gel by introducing fluidizing gas into a reactor at least partially filled with silica gel particles so as to form a fluidized bed of the silica gel particles; and introducing a liquid reagent into the reactor so as to modify the surface of the silica gel particles by covalently bonding at least one functional group thereto. The liquid reagent may be prepared such that the functional group includes a 3-aminopropylsilyl group, a N-[2-aminoethyl]-3-aminopropylsilyl group, a N-[N-(2-aminoethyl)-2-aminoethyl]-3-aminopropylsilyl group or a mixture thereof. The liquid reagent can be an aqueous or non-aqueous solution containing 3-aminopropyltriethoxysilane, 3-aminopropyltrimethoxysilane, N-[3-(trimethoxysilyl)propyl]-ethylenediamine and/or N′-[3-(trimethoxysilyl)propyl]-diethylenetriamine.

### CROSS-REFERENCE TO RELATED APPLICATION

This application claims priority under 35 U.S.C. §119 to U.S. Provisional Application No. 60/540,070 entitled METHOD OF MAKING SURFACE MODIFIED SILICA GEL and filed on Jan. 30, 2004, the entire content of which is hereby incorporated by reference.

### BACKGROUND

A wide variety of materials have been suggested as filters for tobacco smoke. Such filter materials include cotton, paper, cellulose, and certain synthetic fibers. These filter materials, however, only remove particulates and condensable components from tobacco smoke. They have little or no effect in removing certain gaseous components, e.g., aldehydes, from tobacco smoke.

While various filter materials have been proposed for filtering air and tobacco smoke, proposed are economical methods of producing filter material effective in selective removal of constituents of gas streams such as air or tobacco smoke.

### SUMMARY

A method of manufacturing surface modified silica gel effective as a filtering agent which removes a gaseous component of a gas mixture comprises the steps of preparing the surface modified silica gel by introducing fluidizing gas into a reactor at least partially filled with silica gel particles so as to form a fluidized bed of the silica gel particles; and introducing a liquid reagent into the reactor so as to modify the surface of the silica gel particles by covalently bonding at least one functional group thereto.

In a preferred embodiment, the liquid reagent may be comprise a functional group such as an aminopropylsilyl group, a N-[2-aminoethyl]-3-aminopropylsilyl group and/or a N-[N-(2-aminoethyl)-2-aminoethyl]-3-aminopropylsilyl group. The liquid reagent can be an aqueous or non-aqueous solution containing 3-aminopropyltriethoxysilane, 3-aminopropyltrimethoxysilane, N-[3-(trimethoxysilyl)propyl]-ethylenediamine and/or N′-[3-(trimethoxysilyl)propyl]-diethylenetriamine.

A preferred functional group is an aminopropylsilyl group, and more preferably, a 3-aminopropylsilyl group. The most preferred functional group/silica gel system contains 3-aminopropylsilyl groups bonded to silica gel (hereinafter referred to as “APS silica gel”). The surface modified silica gel can selectively remove gaseous components such as polar compounds (e.g., aldehydes and hydrogen cyanide) from tobacco smoke.

According to another preferred embodiment, the surface modified silica gel may be incorporated in a cigarette filter wherein the reactive functional group chemically reacts with components of a smokestream that are targeted for removal.

In a preferred embodiment, the fluidizing gas comprises air (e.g,. dry air), steam, carbon dioxide, argon, helium and/or nitrogen. Preferably, the fluidizing gas is introduced into the reactor at a velocity of about 15 to 50 feet per minute. The fluidized silica gel particles are preferably heated to a temperature of at least about 30 to 100° C., more preferably about 40 to 50° C. prior to introduction of the liquid reagent into the reactor. In a preferred embodiment, the silica gel particles are heated by heat transfer from an inner wall of the reactor.

The temperature of the fluidized silica gel particles is preferably controlled along with the gas flow rate and liquids addition rate, such that the volatile liquids evaporate about as fast as they are being added to the system. In order to minimize defluidization, which can adversely impact effective mixing, it is preferable that the liquid reagent not substantially accumulate in the fluidized bed. A certain net accumulation of liquid can be accommodated at any one time, and the extent of this can be determined by observation of the behavior of the system as it operates.

In a preferred embodiment, an aqueous liquid may be first introduced to the reactor onto the fluidized silica gel by dripping from the top of the fluidized bed to provide an environment for hydrolysis of a liquid reagent. The liquid reagent may be introduced into the reactor in the same manner as the aqueous liquid while silica gel particles are heated to a temperature of about 30 to 100° C., preferably about 40 to 50° C. In another preferred embodiment, the aqueous liquid and/or liquid reagent can be sprayed onto the fluidized bed of silica gel particles.

In a preferred embodiment, the surface modified silica gel comprises amino-modified silica gel in the form of particles having a mesh size of about 10 to 60. The total nitrogen content of the amino-modified silica gel is preferably in the range of about 0.5 to 8 percent by weight, and more preferably about 1 to 5 percent by weight.

In another preferred embodiment, the surface modified silica gel particles are contacted with an aqueous solution such as water, e.g., de-ionized and/or distilled water, while maintaining the fluidized bed of surface modified silica gel particles at a temperature of about 30 to 100° C.

The method further comprises optionally curing the surface modified silica gel in the fluidized bed by heating the silica gel particles to a temperature of at least about 100° C. for about 30 to 90 minutes.

### BRIEF DESCRIPTION OF THE DRAWINGS

FIG. 1 shows a fluidized-bed reactor system used in accordance with an embodiment.

FIG. 2 is a graph of the reactor operating temperature versus time for three different locations inside the reactor: (1) lower portion of the fluidized bed; (2) middle of the fluidized bed; (3) above the fluidized bed.

FIG. 3 is a perspective partially exploded view of a cigarette wherein the surface modified silica gel is incorporated in a three-piece filter element having two end plugs of filter material such as cellulose acetate and a middle space filled with surface modified silica gel granules.

### DETAILED DESCRIPTION OF PREFERRED EMBODIMENTS

A method of making surface-modified silica gel utilizes fluidized bed technology wherein a compound or reagent to be bonded to the silica gel is added in the liquid phase. This method has the advantages of employing fluidized bed technology, which (i) requires fewer processing steps (no need for solid-liquid separation as with the slurry method); (ii) produces a more uniform product than other methods; and/or (iii) generates reduced waste effluents. The method has an additional advantage in that it may be used to bond a broad spectrum of reagents to silica gel, including reagents that undergo desired reactions during the method.

The method utilizes fluidized bed technology, e.g., fluidized bed technology suitable for applications in chemical processing industries, including drying and cooling of various solid materials, gas phase catalytic polymerization, calcination of inorganic materials such as aluminas, silicas, as well as a variety of other inorganics, and a broad range of gas/solids and gas/liquid/solid reactions. In such processing, it is desirable to use gas/solid contacting of particles such as granules, crystals, and powders, the particles being suspended in a vertical gas flow that ensures an intimate mixing between the particles and the fluidizing gas medium.

This phenomenon can be used to achieve heat and mass transfer operations provided that (i) a stable well-fluidized bed can be formed; (ii) the product will flow in continuous operations; (iii) entrained particles can be handled and efficiently removed, and/or (iv) the off-gases are vented or recycled.

In the fluidized bed process, solid particles become fluidized when a gas or gas mixture flows upwards (opposed to the force of gravity) through the bed of solid particles leading to an increase in inter-particle distance as the particles become suspended by the force of the mobile gas phase. At a certain velocity of a gas or gas mixture, enhancement of inter-particle distance leads to bulk movement and circulation of particles causing the suspended solids to behave like a liquid phase, and allowing the mass of suspended solids to conform to the shape of the container.

U.S. Pat. No. 6,209,547 and WO 00/25610, the disclosures of which are hereby incorporated by reference, disclose a filter having a reagent which chemically reacts with and removes a gaseous component such as aldehydes from an air stream, the reagent containing functional groups covalently bonded to a non-volatile inorganic substrate.

The preferred functional groups are 3-aminopropylsilyl groups, which are covalently bonded to silica gel (APS silica gel). Other preferred surface modified silica gels include aminoethylaminopropylsilyl silica gel (AEAPS) and aminoethylaminoethyl-aminopropyl silica gel (AEAEAPS). The APS can be made by mixing 3-aminopropyltriethoxysilane with silica gel in a water and ethanol (or toluene) solvent, heating the mixture to allow the 3-aminopropyltriethoxysiloxane to react with and chemically bond to the silica gel surface. The reaction mixture is decanted, and the reaction product is optionally rinsed with a solvent and dried in an oven.

The surface modified silica gel (e.g., APS silica gel) is prepared via fluidized bed technology. Compared to a technique wherein APS silica gel is made by using an aqueous slurry, the fluidized bed technique provides equivalent or better binding of reagent functional groups to the silica gel with negligible waste of reagent.

The following examples are provided for illustrative purposes. Any variations in the exemplified compositions and methods that occur to the skilled artisan are intended to fall within the scope of the claims.

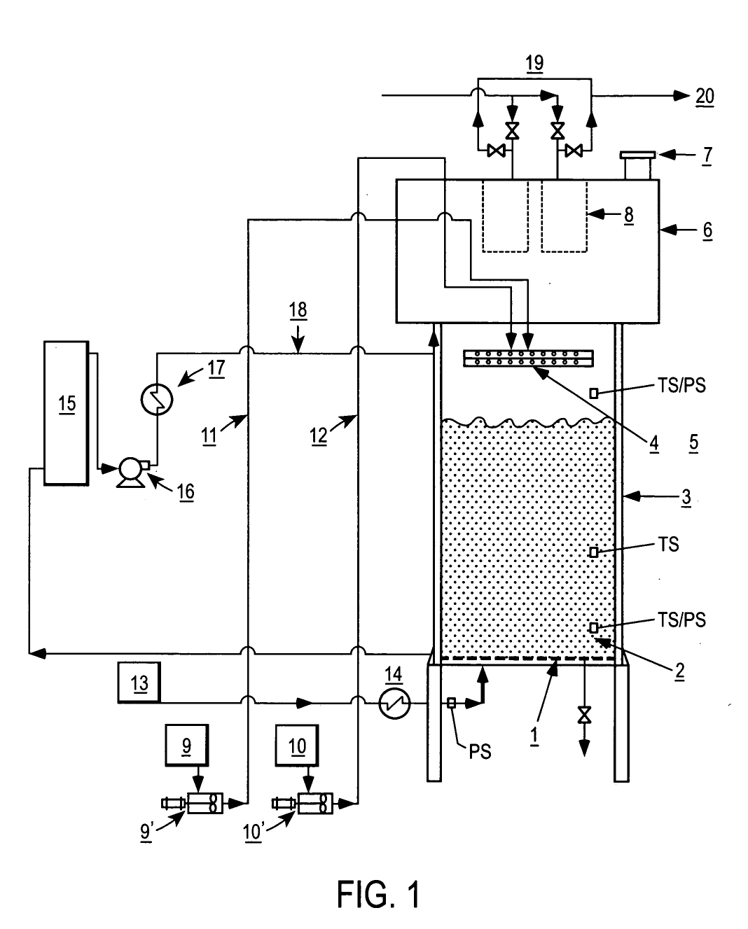

The preparation of surface modified silica gel was carried out in a fluidized-bed reactor system employing the fluidizing bed arrangement shown in FIG. 1. As shown, the fluidized bed reactor is a rectangular vessel 3 (e.g., 1 ft³, ½′ depth×1′ width×2′ height), equipped with a screw-plate gas distributor 1. The distributor 1 provides support for the fluidized bed material (silica gel) 2, and establishes the needed pressure drop to ensure a uniform gas velocity distribution in the fluidized bed. Liquid such as water from a tank 9 and reagent from a tank 10 can be supplied to perforated tubes 4 located above the fluidized bed of silica gel 2 by suitable pumps 9′ and 10′ through tubing 11 and 12. The vessel is flanged to a freeboard section 6 containing a port 7 for feeding a solid material (i.e., silica gel particles) into the bed particles in the vessel. A gas such as nitrogen is introduced into the bed after going through a heating arrangement such as an electrical pre-heater 14 from a fluidizing gas supply assembly 13. An automatic blowback device 19 for introducing a gas such as nitrogen can be incorporated in a filter assembly 8 to clean a pair of filters of excess collected particulate matter and the off gas can be sent to a burner 20 before being released to the atmosphere. A valving arrangement allows one of the filters to be cleaned at a time. The reactor is preferably heated through the two side walls by a hot oil heating system comprising a hot oil tank 15, a pump 16, a heat exchanger 17 and associated piping 18. After completion of the process, the surface modified silica gel is removed via an outlet at the bottom of the reactor. Temperature sensors (TS) at different levels in the fluidized bed can be used to assess the temperature homogeneity of the bed, i.e., the bed can be considered well-mixed if the temperatures in the various parts of the bed are only slightly different. Pressure sensors (PS) at different locations in the system can also provide useful process information.

Commercially available silica gel was used in the test as the substrate to which a chemically functional group was attached. Commercially available aminopropylsilane (APS) reagents were obtained from Sigma Aldrich Chemical Company, Milwaukee, Wis., as was the ethyl alcohol (95% or 100%). Distilled water was used as a hydrolysis agent for the APS reagents. Nitrogen was employed as the fluidizing gas.

An experimental procedure for preparation of surface modified silica gel is as follows. Other procedures with different rates of addition and/or heat transfer are given in later Examples 1-5.

Fifteen pounds of mesoporous silica gel (in the mesh sizes specified below) was loaded into the reactor. The bed of silica gel was then fluidized by nitrogen that was flowed into the reactor at a linear velocity of 15 feet per minute. Next, about 5 liters of distilled water was sprayed onto the silica gel particles at a rate of about 0.1 liters per minute. In the meantime, nitrogen gas was heated to about 25° C. by an electrical pre-heater prior to entering the reactor and the velocity of the gas was increased to 30 feet per minute. Then, the fluidized bed was heated to 48° C., and a mixture of two liters of APS reagent (e.g., 3-aminopropyltriethoxysilane) and four liters of ethyl alcohol was sprayed from the top of the bed into the fluidized silica gel at a rate of about 0.125 liters per minute. These rates and temperatures were selected as a result of calculations designed to balance the rate of addition of liquid reagent with the evaporation rate of the solvent present. To maintain the bed fluidization, excess solvent was not allowed to accumulate. The calculations assumed vapor-saturation of the exiting gas phase and were functions of introduced gas flow and solvent vapor pressures at the selected temperature. After that, about 3 liters of distilled water was sprayed into the fluidized bed at a rate of about 0.1 liters per minute. The fluidized bed was then heated to 105° C. for about one hour to drive off the residual reagent and solvents inside the particles, and to complete the binding process of the reagent to the silica gel, i.e., the heating achieves curing of the surface-modified silica gel. Finally, the fluidized bed was allowed to cool to room temperature. The final product was discharged into a polyethylene lined cardboard drum from the reactor via the product exit port at the bottom of the reactor.

The fluidized characteristics of silica gel used in the following examples were determined from an experimental bench-top fluidizing test using dry air as the fluidizing gas. The incipient fluidization velocity, operating velocity, and maximum velocity were found to be 7 feet per minute, in the range of 15 to 30 feet per minute, and 50 feet per minute respectively. At the operating velocities, the bed depth increases 17% to 33% after fluidization. The overall quality of fluidization was found to be good, i.e., neither slugging nor channeling occurs. These values vary somewhat with the particle size and density of the silica gel used.

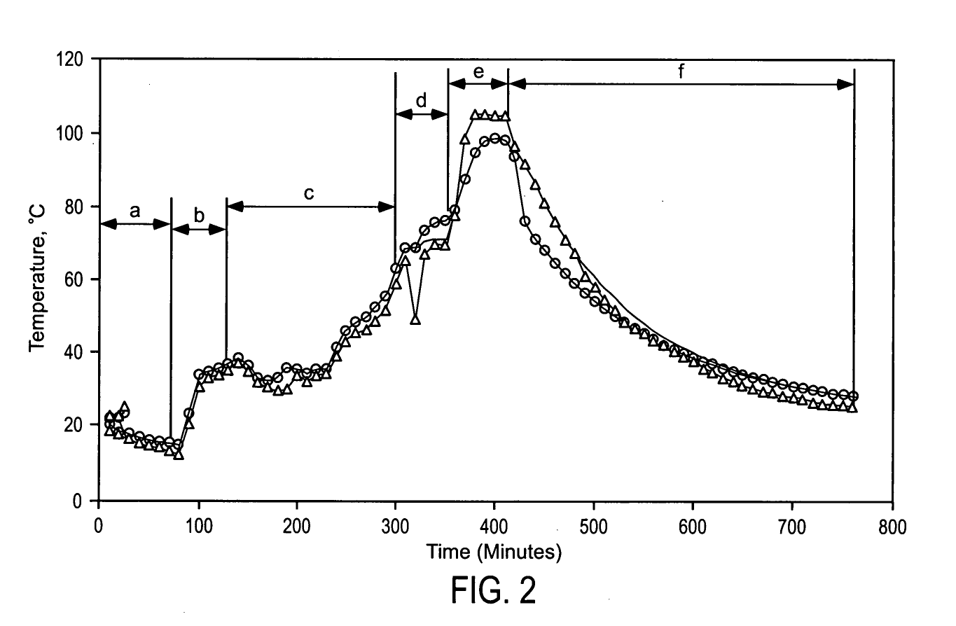

FIG. 2 shows the operating temperatures at three different locations inside the reactor during a process of making surface modified silica gel: (1) lower fluidized bed near the bottom plate designated by (Δ); (2) middle fluidized bed designated by solid line; (3) just above the fluidized bed designated by (o). Steps a-f are: (a) add water, (b) heating, (c) add reagent, (d) add water, (e) heating and curing, (f) cooling. The fact that the temperature at the lower section near the bottom was close to the temperature at the middle section in the fluidized bed indicates good circulation and that the fluidized bed is being well maintained. An excellent fluidization existed when the water was sprayed from above and as the fluidized bed was heated to 40° C.

To determine whether or not the drying/curing step had gone to completion in the fluidized-bed reactor, a test sample of the final product was dried and cured further in an oven overnight at 105° C.

Samples of both the directly-drawn material and the further-cured material were subjected to elemental analysis to determine the contents of silicon, carbon, hydrogen and nitrogen. The elemental analysis results show no significant difference between the directly-drawn sample and the further-cured sample. This means that after the fluidized bed processing the additional drying or curing step did not make a significant difference in terms of the amount of nitrogen bonded into silica gel or in terms of the carbon content. For example, had residual ethoxy groups remained in the product as made by the fluidized bed method, then the curing step would have driven them off, and analytical results including C/N ratios would have changed. Thus, the additional curing step was found to be optional.

Physical characterization of experimental samples was also conducted to determine surface area, pore size distribution, and pore volume by using the BET method.

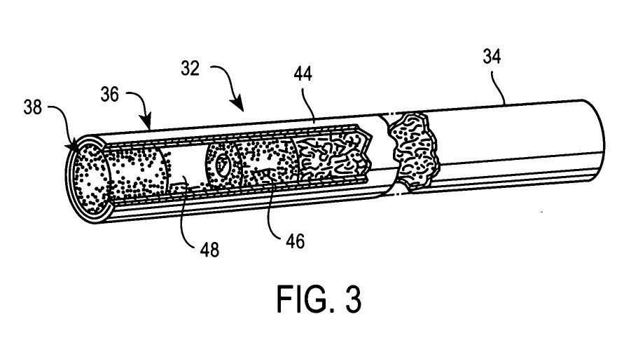

The surface-modified silica gel samples were incorporated into cigarettes in a three-piece filter element having two end plugs of filter material such as cellulose acetate with a middle section filled with surface-modified silica gel granules. FIG. 3 shows such a cigarette 32 comprised of a tobacco rod 34 and a filter portion 36 in the form of a plug-space-plug filter having a mouthpiece 38, a plug 46, and a space 48. The space 48 is filled with surface modified silica gel particles. The tobacco rod 34 and the filter portion 36 are joined together with tipping paper 44. The cigarettes were then machine smoked. The fourth puff smoke was analyzed by using a GC-MS method.

In a preferred embodiment, the liquid reagent is an aqueous or non-aqueous solution containing 3-aminopropyltriethoxysilane, 3-aminopropyltrimethoxysilane, N-[3-(trimethoxysilyl)propyl]-ethylenediamine and/or N′-[3-(trimethoxysilyl)propyl]-diethylenetriamine or derivatives thereof that form in the solution. For example, due to reactions in the solution, derivatives of one or more of the functional groups can be present in the solution.

To create the surface modified silica gel, silica gel can be treated with APS, AEAPS and/or AEAEAPS reagents which provide different amounts of nitrogen and carbon after the modified silica gel has been thoroughly cured. The theoretical C/N ratio ranges from about 2.0 to 2.6. For instance, when the silica gel is treated with APS reagent the stoichiometric C/N ratio of 3C/N is 2.573 and samples made with such reagent were found to have C/N ratios of 2.48, 2.60 and 2.62 (Examples 1, 2 and 5). When the silica gel is treated with AEAPS the stoichiometric C/N ratio of 5C/2N is about 2.14 and samples made with such reagent were found to have C/N ratios of 2.10 and 2.11 (Examples 3 and 4). The C/N ratios for the samples prepared according to Examples 1-5 show completion of the curing process via curing in the fluidized bed reactor.

As an overview, a surface-modified product can be obtained and the process can be carried out in a highly economical manner by use of the fluidized bed technique. The addition of liquid reagent to the fluidized silica gel particles minimizes reagent waste. Furthermore, by curing in the fluidized bed reactor the surface modified silica gel can be prepared in an efficient manner while minimizing wasted energy used to heat the silica gel. The distributional homogeneity of the reagent can be improved by adding water to the silica gel particles before addition of the liquid reagent. The liquid reagent preferably includes a high volatility liquid such as ethanol which cools the silica gel as it evaporates. During the process, water evaporation also contributes to the cooling. To offset such cooling, the silica gel is preferably heated by the inner walls of the reactor and by the preheated fluidizing gas. After the liquid reagent has been added, water is preferably added to aid in removal of ethanol from the silica gel and heat is supplied via the reactor inner wall to compensate for the cooling effect as ethanol and/or water continues to evaporate. Preferably, the heating medium (e.g., hot oil) that is circulated in the wall of the reactor is heated to a higher temperature (e.g., to about 110 to 160° C. or about 10 to 50° C. warmer than the target temperature inside the fluidized bed) to bring the silica gel to the curing temperature (e.g., 100 to 110° C.).

### EXAMPLE 1

### APS Silica Gel: 35×60 Mesh

About 15 pounds of granular chromatographic grade silica gel (particle size of 35×60 mesh and average pore size of 150 Angstroms obtained from Grace Davison) was loaded into the fluidized bed reactor. This generated a static bed depth of 16 inches. The silica gel then was fluidized via nitrogen gas at a velocity of 35 feet per minute. The expanded fluidized bed had a bed depth of 20 inches, which corresponded to 25 percent expansion. In the meantime, hot oil coils inside the two vertical wall panels provided indirect heat to the fluidized silica gel, and an electric heater preheated nitrogen gas before the nitrogen gas entered the fluidized bed.

About 4 liters of distilled water was sprayed into the fluidized bed over a period of 15 minutes while the fluidized bed was maintained at room temperature. Then the water spray was stopped and the bed temperature was raised to about 45° C. from the indirect heating. Once the bed temperature was stable at about 45° C., about 3 liters of γ-aminopropyltriethoxysilane (APS reagent) from Sigma Aldrich Chemical Company diluted with 4 liters of 95% ethyl alcohol was sprayed into the fluidized silica gel over a period of 75 minutes while the bed temperature was maintained at about 45° C. Afterwards, about 3 additional liters of distilled water was sprayed into the fluidized silica gel over a period of 10 minutes to ensure the completion of the reaction. The fluidized bed temperature was then raised to 105° C., and the bed temperature was maintained at about 105° C. for 35 minutes for drying and curing. After this, the product was cooled to room temperature for discharge. The final product weight was found to be about 17 pounds.

Physical properties, chemical composition, and the reduction of cigarette smoke constituents were measured and the results are shown in Table 1 below.

TABLE 1

| | | Control | | APS- |
|---|---|---|---|---|
| | | (1R4F) | Silica Gel | Silica Gel |
| Physical | Particle size (Mesh) | N/A | 35 × 60 | 35 × 60 |
| Properties | Surface area (BET) (m²/g) | N/A | 297 | 235 |
| | Total pore volume (cc/g) | N/A | 1.1 | 0.75 |
| | Pore size (Angstroms) | N/A | 136 | 112 |
| | Shape | N/A | Granular | Granular |
| Chemical | Carbon (%) | N/A | N/A | 4.00 |
| | Nitrogen (%) | N/A | N/A | 1.61 |
| | Hydrogen (%) | N/A | N/A | 1.40 |
| | Carbon/Nitrogen ratio | N/A | N/A | 2.48 |
| Reduction | HCN (%) | 0 | 34 | 87 |
| | Formaldehyde (%) | 0 | 13 | 43 |
| | Acetaldehyde (%) | 0 | 43 | 92 |
| | Acrolein (%) | 0 | 77 | 88 |

The table shows that the filters made of APS-silica gel can reduce more than 40% formaldehyde, and more than 80% HCN and acetaldehyde and acrolein from cigarette smoke.

### EXAMPLE 2

### APS Silica Gel: 14×40 Mesh

Similar to Example 1 but using instead about 15 pounds of granular silica gel (particle size of 14×40 mesh and average pore size of 150 Angstroms obtained from Grace Davison).

For the resulting product, the physical properties, chemical composition, and the reduction of cigarette smoke constituents were determined and the results are shown in Table 2 below.

Table 2 shows that cigarette filters incorporating the larger particle size distribution of APS-silica gel are not as effective as finer particle APS-silica gel in reducing aldehydes.

TABLE 2

| | | Control | | APS- |
|---|---|---|---|---|
| | | (1R4F) | Silica Gel | Silica Gel |
| Physical | Particle size (Mesh) | N/A | 14 × 40 | 14 × 40 |
| Properties | Surface area (BET) (m²/g) | N/A | 293 | 227 |
| | Total pore volume (cc/g) | N/A | 1.0 | 0.79 |
| | Pore size (Angstrom) | N/A | 129 | 115 |
| | Shape | N/A | Granular | Granular |
| Chemical | Carbon (%) | N/A | N/A | 6.11 |
| | Nitrogen (%) | N/A | N/A | 2.35 |
| | Hydrogen (%) | N/A | N/A | 1.64 |
| | Carbon/Nitrogen ratio | N/A | N/A | 2.60 |
| Reduction | HCN (%) | 0 | N/A | 63 |
| | Formaldehyde (%) | 0 | N/A | 30 |
| | Acetaldehyde (%) | 0 | N/A | 51 |
| | Acrolein (%) | 0 | N/A | 27 |

### EXAMPLE 3

### AEAPS Silica Gel: 35×60 Mesh

Similar to Example 1 except 6 liters of N-3-trimethoxysilylpropyl-ethylenediamine (AEAPS reagent) diluted with 4 liters of 100% ethyl alcohol was sprayed into the fluidized silica gel over a period of 75 minutes. To shorten the process time, the bed temperature was raised to and maintained at about 45° C. before water was sprayed over the fluidized bed.

Physical properties, chemical composition, and the reduction of cigarette smoke constituents were measured and the results are shown in Table 3 below. When compared with the results of Table 1, it can be seen that AEAPS-silica gel performs similarly to APS-silica gel in reducing various aldehydes.

TABLE 3

| | | Control | Silica | AEAPS- |
|---|---|---|---|---|
| | | (1R4F) | Gel | Silica Gel |
| Physical | Particle size (Mesh) | N/A | 35 × 60 | 35 × 60 |
| Properties | Surface area (BET) (m²/g) | N/A | 296.8 | 125.4 |
| | Total pore volume (cc/g) | N/A | 1.1 | 0.45 |
| | Pore size (Angstroms) | N/A | 135.9 | 112.3 |
| | Shape | N/A | Granular | Granular |
| Chemical | Carbon (%) | N/A | N/A | 9.55 |
| | Nitrogen (%) | N/A | N/A | 4.55 |
| | Hydrogen (%) | N/A | N/A | 2.39 |
| | Carbon/Nitrogen ratio | N/A | N/A | 2.10 |
| Reduction | HCN (%) | 0 | 34 | 71 |
| | Formaldehyde (%) | 0 | 13 | 44 |
| | Acetaldehyde (%) | 0 | 43 | 88 |
| | Acrolein (%) | 0 | 77 | 80 |

### EXAMPLE 4

### AEAPS Silica Gel: 14×40 Mesh

Similar to Example 1 except about 15 pounds of silica gel (particle size of 14×40 mesh obtained from Grace Davison) was placed to the fluidized bed reactor. In addition, N-3-trimethoxysilylpropyl-ethylenediamine was used as the reagent instead of 3-aminopropyltriethoxysilane. The bed temperature was raised to and maintained at about 45° C. before water was sprayed over the fluidized bed.

Physical properties, chemical composition, and the reduction of cigarette smoke constituents were measured and the results are shown in Table 4 below. When compared with Table 2, it can be seen that AEAPS-silica gel performs better than APS-silica gel with larger particle size distribution.

TABLE 4

| | | Control | Silica | AEAPS- |
|---|---|---|---|---|
| | | (1R4F) | Gel | Silica Gel |
| Physical | Particle size (Mesh) | N/A | 14 × 40 | 14 × 40 |
| Properties | Surface area (BET) (m²/g) | N/A | 292.9 | 180.0 |
| | Total pore volume (cc/g) | N/A | 1.0 | 0.64 |
| | Pore size (Angstrom) | N/A | 128.7 | 117.0 |
| | Shape | N/A | Granular | Granular |
| Chemical | Carbon (%) | N/A | N/A | 9.44 |
| | Nitrogen (%) | N/A | N/A | 4.47 |
| | Hydrogen (%) | N/A | N/A | 2.35 |
| | Carbon/Nitrogen ratio | N/A | N/A | 2.11 |
| Smoke | HCN (%) | 0 | N/A | 62 |
| Reduction | Formaldehyde (%) | 0 | N/A | 35 |
| | Acetaldehyde (%) | 0 | N/A | 59 |
| | Acrolein (%) | 0 | N/A | 39 |

### EXAMPLE 5

### APS-Spherical-Silica Gel: 20×50 Mesh

Similar to Example 1 except about 15 pounds of mesoporous spherical silica gel of 20×50 mesh, and of average pore size of about 75 Angstroms from Qingdao Haiyang Chemical Co. LTD, China, was used. The bed temperature was raised to and maintained at about 45° C. before water was sprayed over the fluidized bed.

Physical properties, chemical composition, and the reduction of cigarette smoke constituents were measured and the results are shown in Table 5 below.

TABLE 5

| | | Control | | APS- |
|---|---|---|---|---|
| | | (1R4F) | Silica Gel | Silica Gel |
| Physical | Particle size (Mesh) | N/A | 20 × 50 | 20 × 50 |
| Properties | Surface area (BET) (m²/g) | N/A | 452.1 | 363.1 |
| | Total pore volume (cc/g) | N/A | 1.0 | 0.70 |
| | Pore size (Angstrom) | N/A | 75.9 | 67.3 |
| | Shape | N/A | Spherical | Spherical |
| Chemical | Carbon (%) | N/A | N/A | 7.39 |
| | Nitrogen (%) | N/A | N/A | 2.83 |
| | Hydrogen (%) | N/A | N/A | 2.21 |
| | Carbon/Nitrogen ratio | N/A | N/A | 2.62 |
| Smoke | HCN (%) | 0 | 32 | 6 |
| Reduction | Formaldehyde (%) | 0 | 41 | 33 |
| | Acetaldehyde (%) | 0 | 47 | 61 |
| | Acrolein (%) | 0 | 30 | 93 |

Based on these results, the smoke from cigarettes that have a filter comprising spherical APS-silica gel has only 7% acrolein delivery when compared to control cigarettes 1R4F.

### COMPARATIVE EXAMPLE 6

Aqueous Suspension Process

About 8 liters of 100% ethanol, about 9 pounds of granular silica gel of chromatography grade (35×60 mesh, average pore size of 150 Angstroms obtained from Grace Davison), and about 8 liters de-ionized water were sequentially loaded into a stainless steel reactor of 20 liter nominal capacity. The reactor was equipped with an agitator, a heating/cooling jacket, and a condenser. Nitrogen gas was introduced into the reactor at a flow rate effective to put the silica gel particles into motion. By turning on the agitator motor, a suspension of silica gel particles was obtained. Following agitation, the reacting suspension was heated up to the boiling point of the mixture inside the reactor. At this time, a mixture of about 3.3 pounds of N-3-trimethoxysilylpropyl-ethylenediamine with about 2.2 liters of 100% ethanol was pumped into the reactor via a peristaltic pump while maintaining heating and agitation. The vapor generated was condensed by the condenser and discharged from the reactor system. To compensate for lost solvent, an equal amount (about 2 liters per half-hour) of de-ionized water was pumped into the reaction vessel via the peristaltic pump.

The reaction proceeded about three hours, and then the steam was turned off. The reactor was then cooled below 40° C. by switching to chilled water inside the jacket.

The aqueous slurry product was filtered. The solid product was then placed into an oven at 105° C. for more than 12 hours for curing. The cured surface modified AEAPS silica gel was incorporated into a cigarette in accordance with the construction shown in FIG. 3.

Physical properties, chemical composition, and the reduction of cigarette smoke constituents were measured and the results are shown in Table 6 below.

TABLE 6

| | | Control | Silica | AEAPS- |
|---|---|---|---|---|
| | | (1R4F) | Gel | Silica Gel |
| Physical | Particle size (Mesh) | N/A | 35 × 60 | 35 × 60 |
| Properties | Surface area (BET) (m²/g) | N/A | 296.8 | 242.2 |
| | Total pore volume (cc/g) | N/A | 1.1 | 0.64 |
| | Pore size (Angstrom) | N/A | 136 | 0.83 |
| | Shape | N/A | Granular | Granular |
| Chemical | Carbon (%) | N/A | N/A | 6.61 |
| | Nitrogen (%) | N/A | N/A | 2.935 |
| | Hydrogen (%) | N/A | N/A | 1.77 |
| | Carbon/Nitrogen ratio | N/A | N/A | 2.252 |
| Reduction | HCN (%) | 0 | 34 | 73 |
| | Formaldehyde (%) | 0 | 13 | 61 |
| | Acetaldehyde (%) | 0 | 43 | 89 |
| | Acrolein (%) | 0 | 77 | 70 |

Comparing Tables 1 and 3 with Table 6, the APS-silica gel and AEAPS-silica gel prepared through fluidized bed technology perform at least as well as AEAPS-silica gel produced through an aqueous suspension process.

While the invention has been described with reference to preferred embodiments, it is to be understood that variations and modifications may be resorted to as will be apparent to those skilled in the art. Such variations and modifications are to be considered within the purview and scope of the invention as defined by the claims appended hereto.

1. A method of manufacturing surface modified silica gel effective as a filtering agent which removes gaseous components of a gas mixture, comprising the steps of:
preparing surface modified silica gel by introducing fluidizing gas into a reactor at least partially filled with silica gel particles so as to form a fluidized bed of the silica gel particles; and
introducing a liquid reagent into the reactor so as to modify the surface of the silica gel particles by covalently bonding at least one functional group thereto.

2. The method of claim 1, further comprising curing the surface modified silica gel particles in the reactor while the silica gel is in the fluidized state by heating the surface modified silica gel particles to at least about 100° C. for 5 to 30 minutes or over 30 minutes.

3. The method of claim 1, wherein the functional group includes a 3-aminopropylsilyl group, a N-[2-aminoethyl]-3-aminopropylsilyl group, a N-[N-(2-aminoethyl)-2-aminoethyl]-3-aminopropylsilyl group or a mixture thereof.

4. The method of claim 1, wherein the liquid reagent is an aqueous or non-aqueous solution containing 3-aminopropyltriethoxysilane, 3-aminopropyltrimethoxysilane, N-[3-(trimethoxysilyl)propyl]-ethylenediamine and/or N′-[3-(trimethoxysilyl)propyl]-diethylenetriamine or derivatives thereof that form in the solution.

5. The method of claim 1, wherein the functional group is an aminopropylsilyl group.

6. The method of claim 1, further comprising incorporating the surface modified silica gel in a cigarette filter and optionally attaching the cigarette filter to a tobacco rod to form a cigarette.

7. The method of claim 1, wherein the fluidizing gas comprises air, dry air, steam, carbon dioxide, argon, helium and/or nitrogen.

8. The method of claim 1, wherein the fluidizing gas is preheated to a temperature of at least about 25° C. prior to introduction into the reactor.

9. The method of claim 1, wherein the silica gel particles are heated by heat transfer from an inner wall of the reactor.

10. The method of claim 1, wherein the liquid is sprayed or dripped onto the fluidized bed of silica gel particles.

11. The method of claim 1, wherein the liquid is introduced into a lower portion of the reactor.

12. The method of claim 1, wherein the surface modified silica gel has a mesh size of about 10 to 60.

13. The method of claim 4, wherein the total nitrogen content of the surface modified silica gel is in the range of approximately 0.5 to 8 percent by weight, preferably 1 to 5 percent by weight.

14. The method of claim 1, wherein the liquid comprises a non-aqueous solution.

15. The method of claim 1, wherein the silica gel particles are heated in the reactor to a temperature of about 30 to 100° C. prior to introducing the liquid reagent.

16. The method of claim 1, further comprising curing the surface modified silica gel.

17. The method of claim 16, wherein the curing is carried out in an oven at a temperature of at least about 100° C.

18. The method of claim 1, wherein the silica gel particles have a particle size of about 50 to 1200 μm.

19. The method of claim 1, wherein the silica gel particles are heated in the reactor to a temperature of about 40 to 50° C. prior to introducing the liquid reagent.

20. A method of manufacturing surface modified silica gel particles useful as a filtering agent for removing gaseous components of a gas mixture such as tobacco smoke, comprising:
fluidizing silica gel by passing fluidizing gas through a fluidized bed reactor containing silica gel particles;
heating the silica gel particles to at least about 30° C.;
moistening the silica gel particles by contacting the silica gel particles with an aqueous liquid;
forming the surface modified silica gel particles by contacting the silica gel particles with a liquid reagent that imparts the silica gel particles with at least one functional group;
optionally contacting the surface modified silica gel particles with an aqueous liquid; and
drying the surface modified silica gel particles.

21. The method of claim 20, wherein the fluidizing gas is introduced through a screw plate arrangement at a bottom of the fluidized bed reactor to obtain uniform distribution of the fluidizing gas in the fluidized bed reactor.

22. The method of claim 20, wherein the heating of the silica gel particles is carried out by preheating the fluidizing gas and/or heating at least one inner wall of the fluidized bed reactor.

23. The method of claim 20, wherein the moistening is carried out by passing water, deionized water and/or distilled water through a perforated tube located above the fluidized silica gel particles while maintaining the silica gel particles at about 40 to 85° C.

24. The method of claim 20, wherein the reagent is sprayed or dripped onto the silica gel particles by passing the reagent through a perforated tube located above the fluidized silica gel particles.

25. The method of claim 20, wherein the aqueous liquid comprises water, deionized and/or distilled water sprayed or dripped onto the surface modified silica gel particles after passing through at least one perforated tube located above the fluidized silica gel particles.

26. The method of claim 20, wherein the drying is carried out in the fluidized bed reactor.

27. The method of claim 20, wherein the surface modified silica gel particles are cured in the fluidized bed reactor by heating the surface modified silica gel particles to at least about 100° C. for at least about 30 minutes.

28. The method of claim 20, wherein the surface modified silica gel particles are cured in the fluidized bed reactor by heating the surface modified silica gel particles to about 100 to 120° C. for about 30 to 150 minutes.

29. The method of claim 20, wherein the liquid reagent includes a non-aqueous solvent and the non-aqueous solvent is removed from the surface modified silica gel particles by contacting the surface modified silica gel particles with the aqueous liquid and drying the surface modified silica gel particles at a temperature of at least about 100° C.

30. The method of claim 20, wherein the liquid reagent is an aqueous or non-aqueous solution containing 3-aminopropyltriethoxysilane, 3-aminopropyltrimethoxysilane, N-[3-(trimethoxysilyl)propyl]-ethylenediamine and/or N′-[3-(trimethoxysilyl)propyl]-diethylenetriamine or derivatives thereof that form in the solution.

31. The method of claim 20, wherein the functional group is an aminopropylsilyl group.

32. The method of claim 20, further comprising incorporating the surface modified silica gel in a cigarette filter and optionally attaching the cigarette filter to a tobacco rod to form a cigarette.

33. The method of claim 20, wherein the fluidizing gas comprises air, dry air, steam, carbon dioxide, argon, helium and/or nitrogen.

34. The method of claim 20, wherein the surface modified silica gel has a mesh size of about 10 to 60.

35. The method of claim 30, wherein the total nitrogen content of the surface modified silica gel is in the range of approximately 0.5 to 8 percent by weight, preferably 1 to 5 percent by weight.

36. The method of claim 20, wherein the silica gel particles have a pore size distribution of from about 20 to 1000 Å or about 60 to 200 Å.

37. The method of claim 20, wherein the silica gel particles have an irregular and/or spherical shape.

38. The method of claim 20, wherein the liquid reagent includes ethanol and/or water.

39. The method of claim 20, wherein the liquid reagent comprises ethanol denatured with methanol.

40. The method of claim 20, wherein the liquid reagent comprises at least one alcohol.

41. The method of claim 20, wherein the liquid reagent comprises pure ethanol.

42. The method of claim 20, wherein the liquid comprises an ethanolic solution which includes about 95 volume % ethanol and about 5 volume % water.

43. The method of claim 20, wherein the silica gel particles are contacted with only the liquid reagent and then with only the aqueous liquid.

44. The method of claim 20, wherein the liquid reagent is a derivatizing reagent and the silica gel particles are contacted with a mixture of the derivatizing reagent and the aqueous liquid.

45. The method of claim 20, wherein the liquid reagent includes a solvent and undergoes a reaction with the silica gel particles such that a drop in temperature of the silica gel particles due to vaporization of the solvent and/or reaction byproducts is offset by addition of heat by the fluidizing gas and/or at least one heated wall of the fluidized bed reactor.

46. The method of claim 20, wherein the temperature of the silica gel particles is controlled by adjusting the flow rate of the fluidizing gas, the rate of addition of the liquid reagent and/or the rate of addition of the aqueous liquid into the fluidized bed reactor.

47. The method of claim 20, wherein the temperature of the silica gel particles is controlled by adjusting the temperature of the fluidizing gas and/or the temperature of at least one heated wall of the fluidized bed reactor.

48. The method of claim 20, wherein the fluidizing gas flows through the silica gel particles at a velocity of about 15 to 50 feet per minute.
